(19) United States
(12) Patent Application Publication
(10) Pub. No.: US 2015/0212707 A1
(43) Pub. Date: Jul. 30, 2015

(54) Computer System and Method to View and Edit Documents from an Electronic Computing Device Touchscreen

(71) Applicant: Social Commenting, LLC, Sedona, AZ (US)

(72) Inventor: Michael R. Norwood, Sedona, AZ (US)

(21) Appl. No.: 14/608,789

(22) Filed: Jan. 29, 2015

Related U.S. Application Data
(60) Provisional application No. 61/932,783, filed on Jan. 29, 2014.

(51) Int. Cl. G06F 3/0484; G06F 17/24; G06F 3/0488; G06F 3/0481; G06F 3/0482

(52) U.S. Cl. CPC G06F 3/04842; G06F 3/04812; G06F 3/0482; G06F 3/04883; G06F 3/04886; G06F 17/24

(57) ABSTRACT

An electronic computing device with a touchscreen, and its method of use, to facilitate a user viewing text on the touchscreen. A user is able to designate a distance and relative direction (left, right, above, below) that a user's pointer must contact the selected text. By contacting at the distance and direction, the device displays a bounding box and/or highlights the user selected text without impeding its visibility. If the selected text is within an editable document, then a cursor is automatically displayed and enables a user to edit it (cut, paste, add, delete, etc.). The device also displays a temporary margin for a user's pointer to fit within when it detects that the selected text lies along the border of the touchscreen (left, right, top, or bottom). The bounding box, highlights, and/or margins disappear once the user's pointer ceases to contact the selected text.

### CROSS-REFERENCE TO RELATED APPLICATION

This is a utility patent application being filed in the United States as a non-provisional application for patent under Title 35 U.S.C. §100 et seq. and 37 C.F.R. §1.53(b) and, claiming the priority under 35 U.S.C. §119(e) to the provisional application for patent filed in the United States on Jan. 29, 2014, bearing the title of “Computer System and Method to View and Edit Documents from an Electronic Computing Device Touchscreen”, and assigned application Ser. No. 61/932,783, which is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE DISCLOSURE

The present disclosure is generally related to touchscreen features on electronic computing devices, such as smartphones, that assist a user in viewing and editing a document.

### BACKGROUND OF THE DISCLOSURE

The advent of touchscreens has made the user experience on electronic computing devices, such as on mobile and GPS devices, much more closely integrated to human experience. This is as opposed to the user experience being a purely digital and electronic machine-driven experience. One of the main ways touch screens do this humanization is through the use of fingertip controls rather than mouse or mouse pad controls. Specifically, related to the present disclosure, is the common non-digital experience of using one's fingers to occasionally point to the text in a hardback or paperback book. The advent of prior art systems that allow the use of human fingers to replace mouse actions on touchscreens has provided a major leap forward in this closer-to-reality experience.

However, in many ways, prior art touch controls for highlighting text remain unnatural to normal human functioning. For example, when placing a finger over text in a non-digital situation, such as when reading a paperback or hardback book, the text will be blocked and thus hidden by the finger. So the user will typically point just “below” the text they are reading in a paperback or hardback book.

However, rather than mimicking the way the finger is used for this type of non-digital reading, prior art touchscreens displayed on electronic computing devices commonly employ the appearance of a miniature window above the text and above where the finger is touching to show the text the finger is hiding (e.g. see FIG. 7).

This is unnatural because without the finger over that portion of text, the user can see the entire continuous visual display of text. However, with the finger over that portion of text, the continuity of the visual display is disrupted by the finger and by the miniature window that appears containing the blocked text. Visual perception is an ongoing process involving selecting, grouping, and interpreting visual information. Because the window containing the blocked text is typically very small, the user has to observe text that often has just portions of words in it, making it even more unnatural for the user's visual cortex to process.

A much more natural and native system to the way the human visual cortex reads and processes text is to employ the user's finger to point to the text in the same manner the user would point to text in a non-digital medium. As described, this more natural pointing method is typically accomplished by having the user's finger point just below the text being viewed.

### SUMMARY OF THE DISCLOSURE

The present disclosure describes such a digital pointing method whereby the text above (or, in some instances, below or to the side depending upon the preference selected) may be highlighted. This solves the disruption of visual continuity caused by prior art pointing methods for touchscreens. Although the various embodiments of the present disclosure pertain to improving the visibility of selected text, it may also include images and other screen elements in addition to text.

Also described in this disclosure is a control for regulating the distance the pointer (e.g. user's finger) may be from the highlighted text. (The text highlighted will more commonly appear above the user's finger). This distance control may be very helpful, for example, for users with very large fingers. These users may need more space between their finger and the text their finger is highlighting or reading than a user with much smaller fingers. This is because larger fingers may have a greater tendency to cover up more text than smaller fingers.

Also described in this disclosure is a method of creating a bounding box and/or highlighting user selected text without impeding the visibility of the selected text. If the selected text is within an editable document (e.g. a Microsoft® Word document), then a cursor is displayed that enables a user to edit the selected text (e.g. cut, paste, add, delete, etc.).

Also described in the present disclosure is a feature that automatically creates a margin if the page does not natively contain a margin. This margin, for example at the bottom of a page of text, would be created if there were no space for the user's finger at the bottom of a touchscreen to highlight the text just above it. According to another user preference control, the margin may or may not disappear after the reader is no longer touching the screen at that point.

### BRIEF DESCRIPTION OF THE DRAWINGS

The above and other features, aspects, and advantages of the present disclosure will become better understood with regard to the following description, appended claims, and accompanying drawings where:

FIG. 1 is a block diagram of one embodiment of an electronic computing device with a touchscreen display.

FIG. 2 is a flowchart of steps conducted by the user's electronic computing device for generating the Finger Control Window.

FIG. 3 is a flowchart of steps conducted by the user's electronic computing device for creating a bounding box around and/or highlighting of user selected text.

FIG. 4 is a flowchart of steps conducted by the user's electronic computing device for creating margins next to user selected text.

FIG. 5 is a diagram illustrating one embodiment of the Finger Control touchscreen display.

FIG. 6 is a diagram illustrating a digital touchscreen displaying text prior to contact by a user's pointer.

FIG. 7 is a diagram illustrating a prior art method of displaying a window of parts of words of selected text on a digital touchscreen.

FIG. 8 is a diagram illustrating one embodiment of the control and bounding box feature of the present disclosure.

FIG. 9 is a diagram illustrating another embodiment of the highlight control bar feature of the present disclosure.

FIG. 10 is a diagram illustrating one embodiment of the Highlighting control bar comprising a Finger Control Window display element/key.

FIG. 11 is a diagram illustrating text that has little or no margin on a touchscreen.

FIG. 12 is a diagram illustrating the user touching on top of the bottom line of text on the touchscreen to highlight text above it.

FIG. 13 is a diagram illustrating the automatic creation of a bottom margin when the user touches the bottom line of text in a pre-designated (margin generating) manner to highlight text in the bottom line.

FIG. 14 shows an alternate embodiment of this margin-generating feature comprising the entire text becoming a certain percentage smaller to create margins in all four borders of the touchscreen.

### DETAILED DESCRIPTION

### System Architecture

Various embodiments of the presently disclosed subject matter may include or be embodied in the form of computer-implemented methods or processes and apparatuses or electronic computing devices for practicing those methods or processes; and, in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. As such, a computing device operates as a machine and the inner workings of that machine are determined by instructions executed by a processing unit, hardware switches and/or a combination of both.

The various embodiments of the present disclosure may also be in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

And, the various embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

Various embodiments may also be implemented as a state-machine comprised of software, hardware (such as electronic, mechanical or electromechanical switches) or a combination of both, and include one or more inputs and one or more outputs, wherein actuation of the inputs result in a particular output. The inputs may be interfaced to a variety of elements such as buttons, other hardware/software components, touch screens or other input devices and the outputs likewise may be interfaced to a variety of elements such as displays, buzzers, other hardware/software components, LEDs, etc.

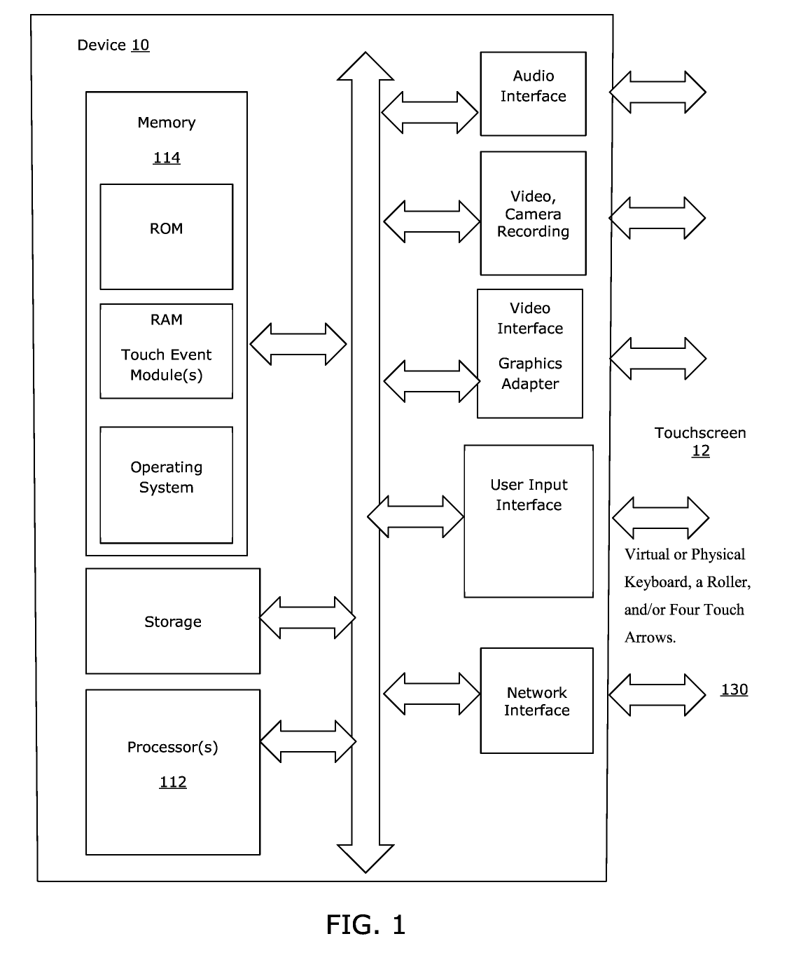

FIG. 1 is a block diagram of one exemplified user's electronic computing device 10 comprising a digital touchscreen 12, such as a tablet and/or smartphone. Device 10 comprises a processing circuit comprising a processor 112, and a memory 114 that stores machine instructions that when executed by the processor 112, cause the processor 112 to perform one or more of the operations and methods described herein. Processor 112 may optionally contain a cache memory unit for temporary local storage of instructions, data, or computer addresses. For example, using instructions retrieved from memory 114, the processor 112 may control the reception and manipulation of input and output data between components of the device 10. In various embodiments, the processor 112 can be implemented as a single-chip, multiple chips and/or other electrical components including one or more integrated circuits and printed circuit boards.

The processor 112 together with a suitable operating system may operate to execute instructions in the form of computer code and produce and use data. By way of example and not by way of limitation, the operating system may be Windows-based, Mac-based, OSX, ANDROID, or Unix or Linux-based, among other suitable operating systems. Operating systems are generally well known and will not be described in further detail here.

Memory 114 encompasses one or more storage mediums and generally provides a place to store computer code (e.g., software and/or firmware) and data that are used by the device 10. The memory 114 may comprise, for example, electronic, optical, magnetic, or any other storage or transmission device capable of providing the processor 112 with program instructions. Memory 114 may further include a floppy disk, CD-ROM, DVD, magnetic disk, memory chip, ASIC, FPGA, EEPROM, EPROM, flash memory, optical media, or any other suitable memory from which processor 112 can read instructions in computer programming languages.

Memory 114 may include various other tangible, non-transitory computer-readable media including Read-Only Memory (ROM) and/or Random-Access Memory (RAM). As is well known in the art, ROM acts to transfer data and instructions uni-directionally to the processor 112, and RAM is used typically to transfer data and instructions in a bi-directional manner. In the various embodiments disclosed herein, various components of the memory 114 may include computer program instructions that when executed by the processor 112 cause the processor 112 to, among other things, recognize certain actions or status changes, such as Touch Event Modules (e.g. Finger Control Window), such as pointer contact events on a touchscreen 12 of the computing device 10.

Processor 112 is generally coupled to a variety of interfaces such as graphics control (e.g. graphical processing unit (GPU)), video interface, audio interface, input interface (e.g. touchscreen data input and/or keypad), and other interfaces, such as camera hardware and software components housed within and/or connected to device 10 for recording and transmitting content. Processor 112 may also be coupled to a network interface that allows the processor to be coupled to another computer or telecommunications network (e.g., internet). More particularly, the network interface generally allows processor 112 to receive information from and to output information to the network in the course of performing various method steps described in the embodiments herein.

In particular, device 10 includes a video adapter, which is an input/output adapter specially designed for graphic output to touchscreen 12. The video interface-graphics adapter may be connected to processor 112 through a high-speed video bus, a bus adapter, and the front side bus, which is also a high speed bus. Additionally, touchscreen 12 may comprises a display screen, such as a Liquid Crystal Display (LCD), that may display a virtual keyboard, roller, and/or four touch arrows, and that includes a touchscreen adapter for translating touches to the screen to commands. The term “touchscreen”, as used herein, is an electronic visual display that can detect the presence and location of a touch (e.g. pointer contact) within the display area and generate signals that identify the type and location of the touching activity. The term generally refers to touching the display of the device with a finger or stylus to enable a user to interact directly with what is displayed.

Device 10 may further have installed within the device's memory, computer instructions for executing the various embodiments of the disclosure (e.g. Finger Control Window display) comprising a native application, a web application, or a widget type application to carry out the methods of the embodiments disclosed herein. In a preferred embodiment, a native application (e.g. computer program product) is installed on the device, wherein it is either pre-installed on the device or it is downloaded from the Internet and activated, such as with a code generated by the system server as a non-limiting example. The native application may be written in a language to run on a variety of different types of devices; or it may be written in a device-specific computer programming language for a specific type of device.

In some embodiments, a web application may reside on a remote server accessed via a network. It may perform basically all the same tasks as a native application, and is usually downloaded in whole or in part to the end user's device 10 for local processing once until deleted, periodically or each time it is used. The web application software can be written as Web pages in HTML and CSS or other language serving the same purpose, with the interactive parts in JavaScript or other language. Or the web application may comprise a widget as a packaged/downloadable/installable web application; making it more like a traditional application than a web application; but like a web application uses HTML/CSS/JavaScript and access to the Internet. And/or device 10 may include a web browser running applications (e.g. Java applets or other like applications), comprising application programming interfaces (“APIs”) to other software applications running on remote servers that provide, for example, cloud based services and comment posting.

### Process Steps for User's Finger Control Selections

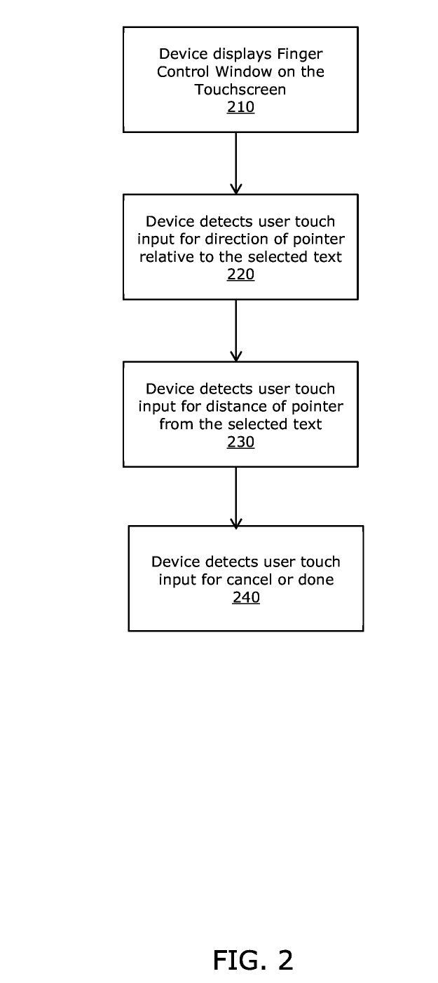

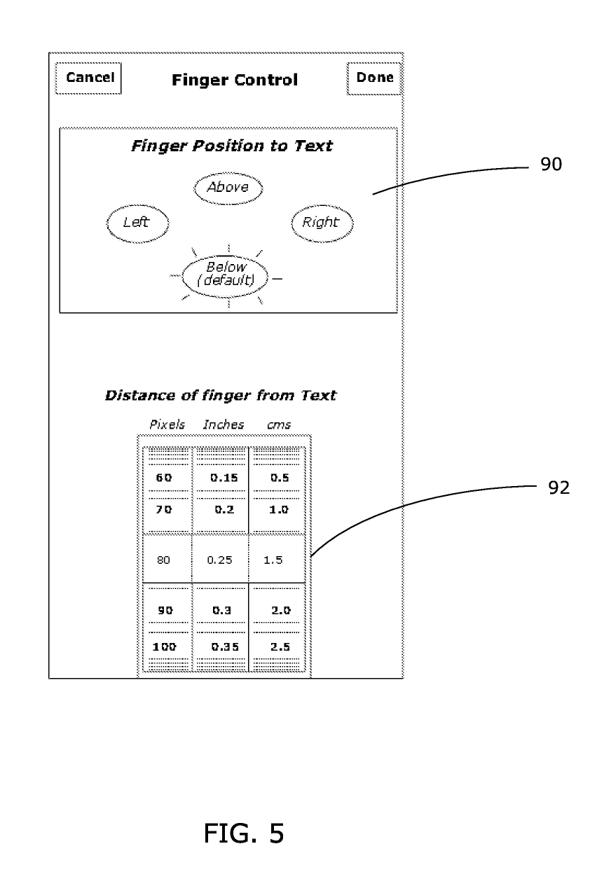

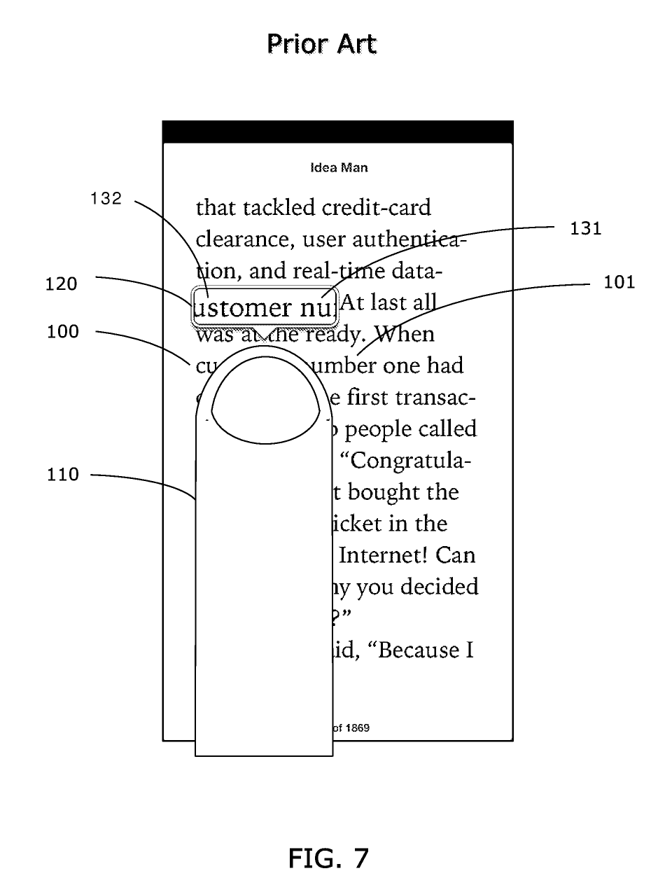

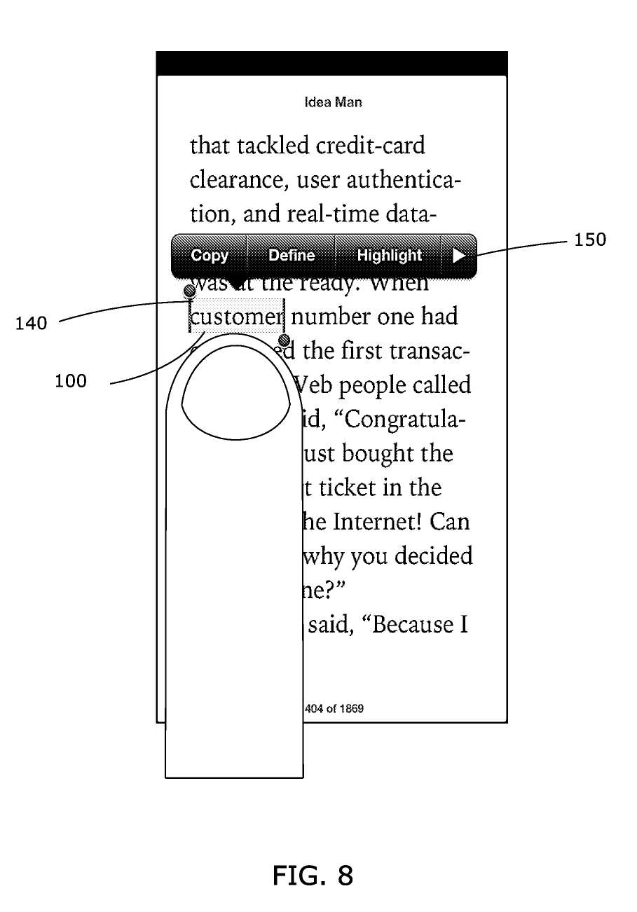

The user may setup their preferences, as disclosed in the flowchart depicting various computer actions in FIGS. 2-4 and as illustrated in FIG. 5, to designate the distance and relative direction from which their pointer needs to contact the touchscreen before the electronic computing device 10 will display the bounding box 140 and/or highlight selected text (see FIGS. 7 and 8, respectively).

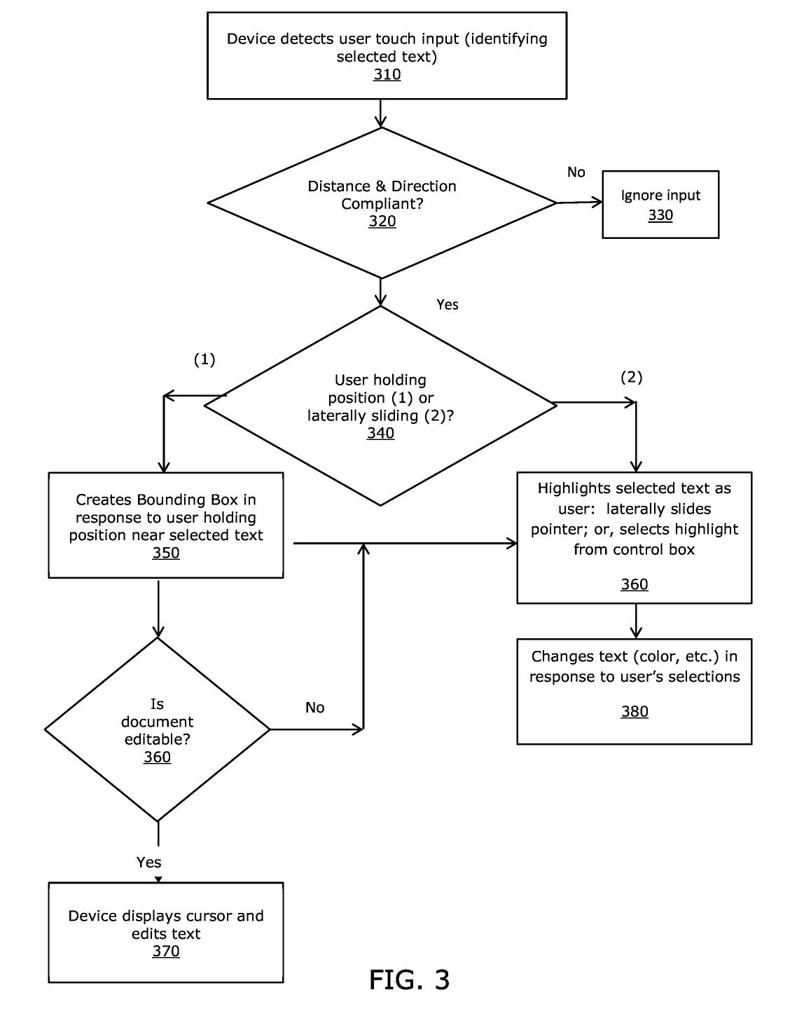

As per the exemplary flowchart of computer actions that may be included in one or more embodiments and as shown in FIG. 2, at step 210 the user's electronic computing device 10 displays a “Finger Control” touchscreen image on a graphical user interface display. This may be done in response to a user's input to navigate to the “Finger Control” touchscreen, such as from a menu options. Device 10 then detects user touch input for the “relative direction” that the user's pointer contacts the touchscreen in relation to the selected text (step 220) (left, above, right below), and the user designated distance of the pointer contact from the text (step 230), in for example units of pixels, inches, or centimeters. Device 10 then receives user input of whether to save their selections (e.g. “Done”), or to cancel them and default to the system designated settings or previous user settings (step 240). It is noted that steps 220 and 230 may be in reverse order; and, that the process of computer steps in FIG. 2 may be done at any time (e.g. after steps of FIG. 3), both as selected by the user.

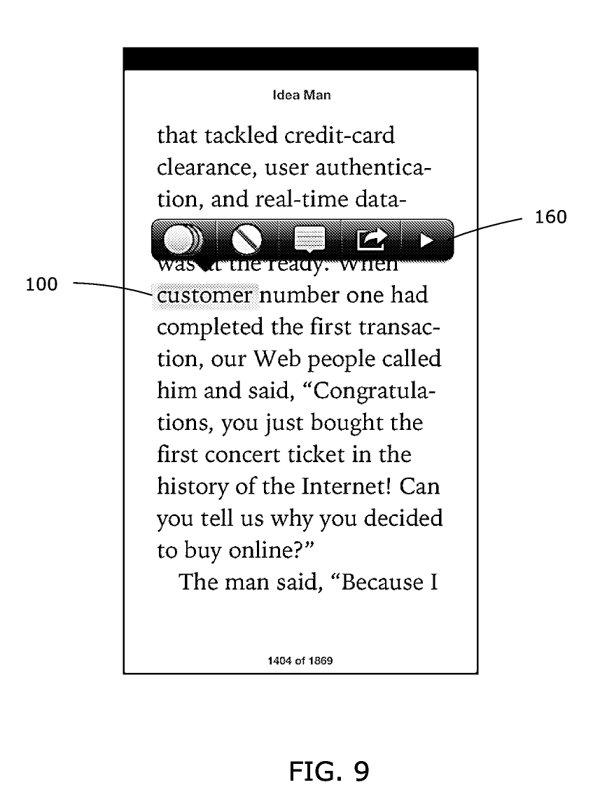

An exemplification of the touchscreen is shown in FIG. 5 and comprises a top window display showing a “Left” “Above” “Right” or “Below (default)” display element 90. The display elements indicate the direction relative to text that the user must contact the touchscreen with their pointer in order to trigger the method steps for generating a bounding box and/or highlighting the text (per FIGS. 8, 9).

Options for the distance may also be displayed on the device touchscreen. For example, a matrix listing distances by different units of measurement may be shown as per FIG. 5, 92, which displays distances in pixels (60-100), inches (0.15-0.35), and centimeters (0.5-2.5).

In alternative embodiments, other user input mechanisms for a user to designate the distance are envisioned within the present disclosure, such as the user inputting the distance and units on a virtual keypad or physical keyboard.

In the absence of the user designating a direction relative to the text 90 and a distance from the text 92, the device 10 will default to its settings.

### Process Steps for Bounding Box and Highlighting

The present disclosure comprises various embodiments for assisting a user in viewing legible text on a digital touchscreen of an electronic computing device, such as creating a bounding box that permits a user to edit the text, zoom in or enlarge the text and/or to highlight the text.

FIG. 3 is an exemplary flowchart of computer steps that may be conducted by various embodiments of the user's electronic computing device in response to the user physically contacting the device's touchscreen with a pointer (e.g. finger, stylus, etc.) when text is displayed on the graphical user interface. “Contacting” may comprise the user tapping, and/or touching and holding in position for a pre-designated period of time (e.g. micro seconds to seconds), and/or touching and dragging a pointer laterally (side-to-side along the line of text), etc. A “pointer” may comprise any apparatus (human or manmade) that a digital touchscreen on a user's electronic computing device can detect and respond to a user's touch input, such as a user's finger or a stylus compatible with a touchscreen of an electronic computing device.

Bounding Box:

FIG. 3, steps 310-340, disclose an exemplary computer processes for creating a bounding box around the selected text, as exemplified in FIG. 7. In step 310, device 10 detects user touch input identifying selected text and determines (in step 320) if the user's pointer is at the distance and relative position or relative direction (left, right, above, below) setup or by default in the Finger Control Window of FIG. 5. If not, then device 10 ignores the contact (step 330). If so, then device 10 determines whether the user is holding their pointer in position (option 1) or is laterally sliding it along the line of text (option 2) (step 340). Highlighting can also occur by sliding the pointer in any direction, including up and down, which in certain embodiments highlights all or portions of the text on the lines where the pointer has slid.

If the user is holding their position, then the device displays a bounding box 120 around the selected text 132 (the word(s) that lie the pre-designated distance and direction from the user's pointer) (step 350). In one embodiment, the length of the bounding box is pre-set or designated, and may be a function of the size of the screen. The bounding box of the present disclosure may comprise any border that partially or fully encloses the selected text temporarily. (For example, the bounding box 140 illustrated in FIG. 8 comprises two distinct end markers and it highlights the text within the markers). It may also comprise one as described in prior art systems, as seen, for example, on the iPad® or iPhone®, and with the ability to extend the bounding box to additional text by the user pulling on the corners of the bounding box 140.

In step 350, in addition to the bounding box 140, a control box 150 may appear (see FIG. 8), displaying input elements (display elements/keys) for other functions, such as “Copy” (as in a copy and paste function in a word document), “Define” (as in searching and displaying the definition of a term as found on the Internet or stored within the device's memory), and “Highlight” (as in highlighting the user selected text). In response to a user selection of the Highlight function, the device will highlight the selected text temporarily (step 360). The bounding box and the highlighting disappear when the user touches another place on the screen other than elements in the bounding box control box 150.

Additionally after the bounding box appears in step 350, the device will determine in step 370 if the selected text is a document that may be edited—such as a Microsoft® Word document, a rich text format document, a plain text document, etc. If it is editable, then in step 370 the device 10 displays a cursor or other user input mechanisms to assist in directing the device and its user in how to edit the document (e.g. cut, paste, delete, add to the selected text).

Highlighting:

The device 10 highlights the selected text when either: the user selects the “Highlight” display element from the control box 150, or the user slides their pointer along the text (step 360). In either case and as illustrated in FIG. 9, once the text is highlighted the user may select other functions from the Highlight control bar 160 (step 380), such as change the highlighting color.

### Bounding Box and Highlighting Exemplifications

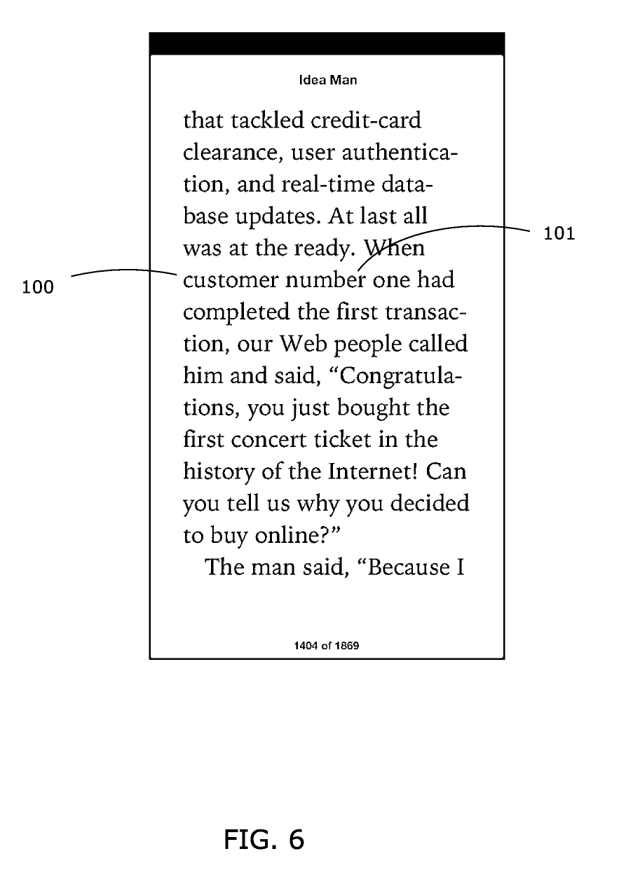

FIG. 6 is an illustration of one embodiment of a digital touchscreen on a user's electronic computing device displaying text, such as from a page of text from iBooks® as displayed on an iPhone®. The displayed words “customer” 100 and “number” 101 are used herein to demonstrate the various embodiments, features, and/or aspects of the present disclosure.

FIG. 7 is an illustration of a prior art method of a window 120 that appears on user selected text wherein only parts of words appear in the window, therefore making it more difficult for the user to comprehend the text. The user's finger 110 is touching a digital touchscreen on an electronic computing device (e.g. smartphone) on top of the words “customer” 100 (i.e. the selected text) and “number” 101. This causes the device to display a window 120 showing the words covered up by the user's finger 110, but the window is too small to show the entire word 100, 101. Instead, the window 120 displays the parts of words “ustomer” 132 and “nu” 131, which does not aid the user in reading the text.

Bounding Box:

FIG. 8 is an illustration demonstrating various embodiments of the bounding box 140 of the present disclosure. When a user contacts a digital touchscreen directly below a line of text displayed on the screen (FIG. 3, step 310) that the user is reading and holds the pointer's position, then the device will generate and display on the touchscreen: a bounding box 140, with a control box 150. In this exemplification, the selected text “customer” 100 is easily viewed within the bounding box 140 on the touchscreen above the pointer (e.g. user's finger).

Highlighting:

If the user selects the “Highlight” key from the control box 150 in FIG. 8, then the Highlight control box 160 appears (see FIG. 9) and the selected text 100 becomes highlighted.

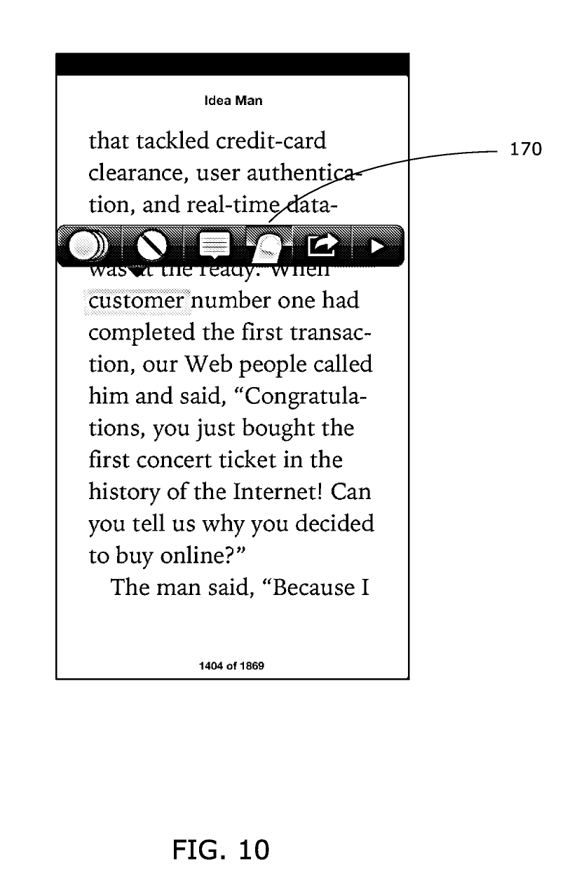

The Highlight control box 160 may comprise a plurality of functions, such as those shown in FIG. 9 and FIG. 10. For example, if the user selects the Finger Control Window 170 as shown in FIG. 10, then device 10 will display the Finger Control Window, such as that shown in FIG. 5. From this display, the user is able to designate the distance and relative direction of the pointer as per the flowchart in FIG. 2.

### Process Steps for Creation of Page Margins

In some embodiments of the disclosure, if the device 10 detects that the user's selected text 100 is tangent to, or lies along the border of, the touchscreen (i.e. far left, right, top or bottom of the screen), then it will create a margin of sufficient size to accommodate the user's pointer. This feature is particularly useful when the user wishes that device 10 detects the user's touch input for any text that may be adjacent to any left, right, top or bottom text border (see controls in FIG. 5, 90).

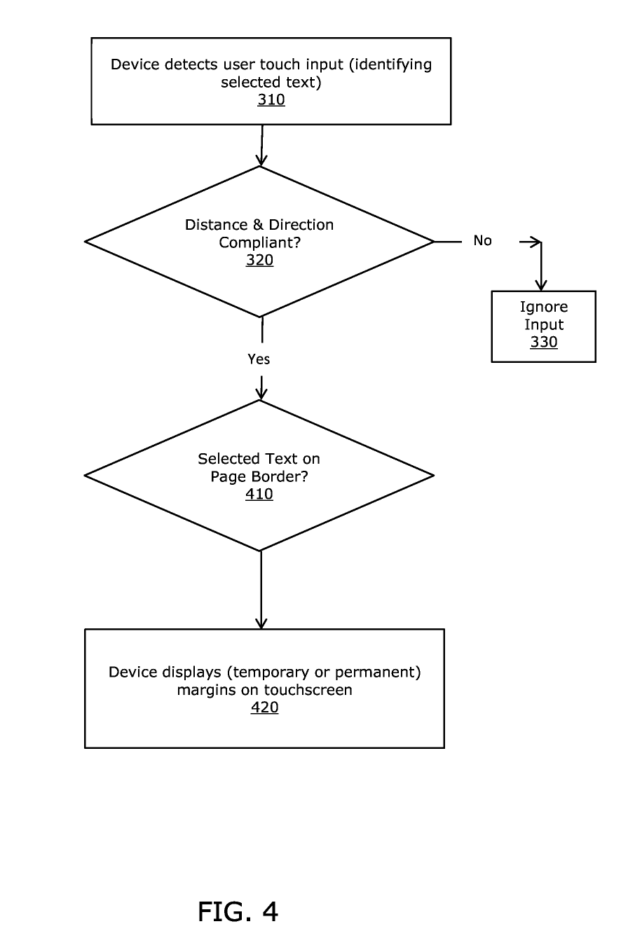

As shown in the computer flowchart of FIG. 4, the initial process steps for displaying a bounding box and/or highlighting selected text are the same steps as for creating a margin. Therefore, the process of creating the margins per the flowchart of FIG. 4 may occur prior to, concurrently or after the device 10 generates a bounding box and/or highlighted text (e.g. steps FIG. 3). In FIG. 4, step 310, device 10 detects user touch input identifying selected text and determines (in step 320) if the user's pointer is at the distance and relative position (left, right, above, below) setup or by default in the Finger Control Window of FIG. 4. If not, then device 10 ignores the contact (step 330). If so, then device 10 determines whether the selected text lies along the border of the touchscreen (left, right, top, or bottom) (step 410).

If so, then device 10 displays a margin on the border of the touchscreen most closely aligned with the selected text, or alternatively around the entire border of the touchscreen (step 420). The margin may also be permanent (e.g. as long as the user is reading from the same document, each page of the document will have the border), or the margin may be temporary such that it disappears along with the bounding box and/or highlighting of the selected text, for example when the user's moves their pointer. The margin is also of sufficient width to accommodate the user's pointer.

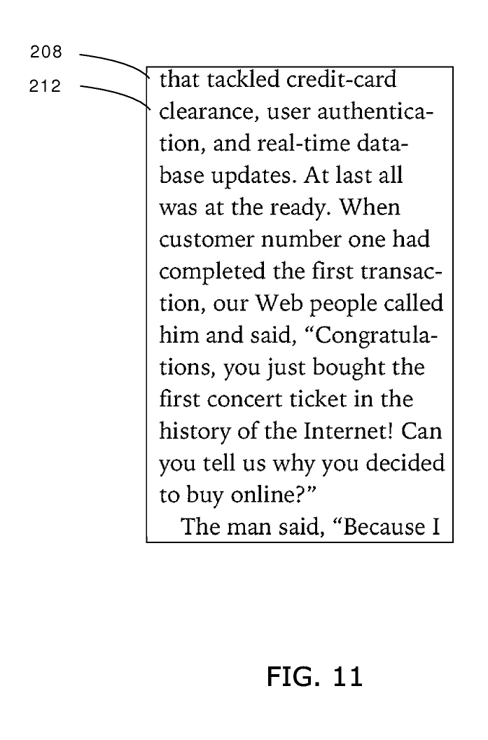

FIGS. 11-15 provide exemplifying illustrations of the sequence of actions that occur to generate a margin when the user selects text on the bottom of the touchscreen. (This sequence would work similarly to create the appropriate margin(s) if the preference control was selected for highlighting text above, to the left or to the right of the user's finger).

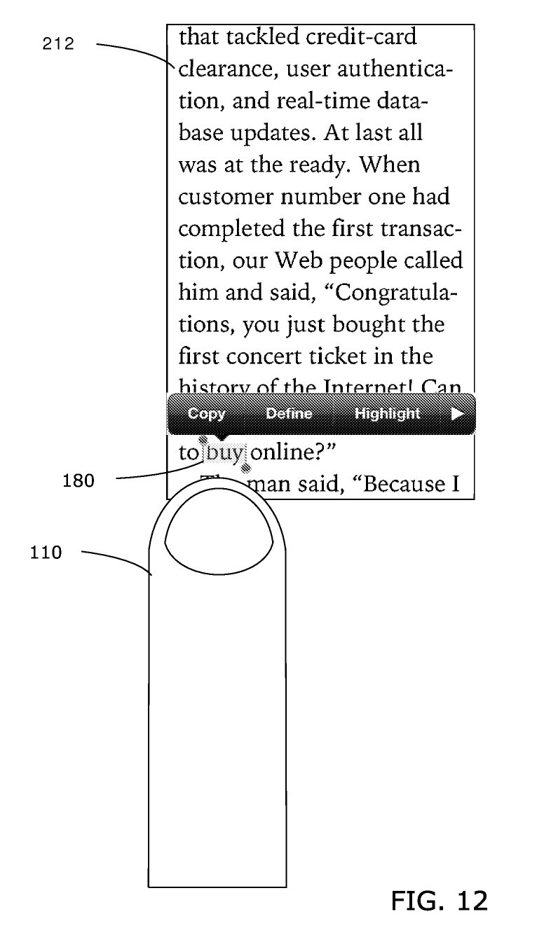

FIGS. 11 and 12 display text that has little or no margin on a touchscreen in which 208 is the first line of text, and 212 is the second line of text. When the user touches the bottom line of text on the touchscreen thus covering up all or part of the bottom line of text (i.e. see FIG. 12, “The man”), then the word “buy” 180 above the finger 110 is highlighted by a bounding box, which the user did not intend to happen.

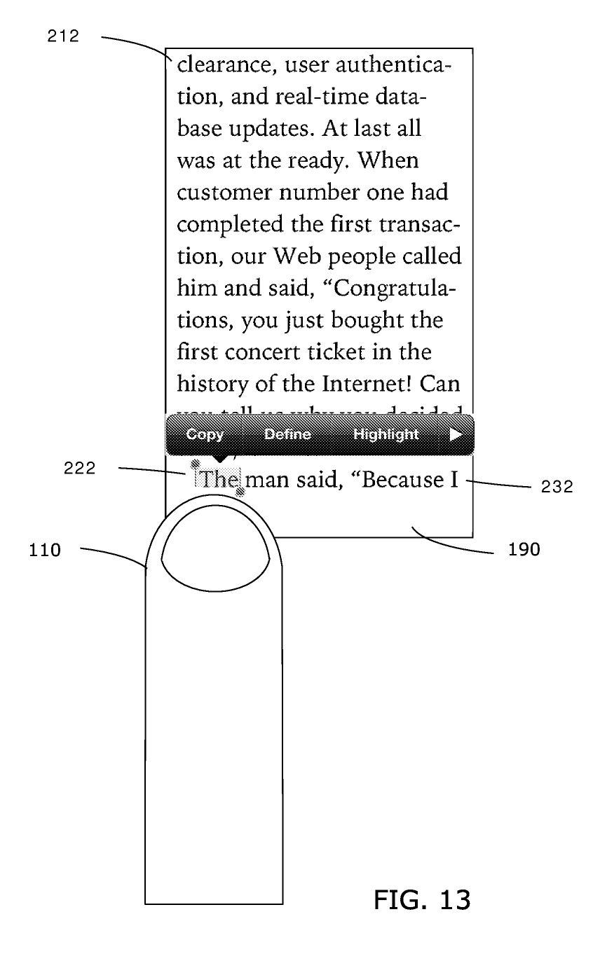

By way of comparison, FIG. 13 displays an exemplification of device 10 creating the bottom margin 190 when the user intends to highlight text in the bottom line (i.e. see FIG. 13, “The man”, 222). A margin is automatically created when the user touches the bottom line of text 232 with their pointer 110 and performs a pre-designated action to create the bottom margin 190. As a non-limiting example, the user dragging their pointer downward from the touchscreen's bottom line of text 232 can also be the initiating action to create the bottom margin 190.

The space for the bottom margin comes from the top line of text (see FIG. 11, 208, “that tackled credit-card”) has been pushed up off the screen by the entire screen of text moving up one line of text higher to make room for the bottom margin 190. Now, the second line of text 212 “clearance, user authentica-” in FIG. 11 becomes the first line of text in FIG. 13.

FIG. 13 also illustrates the result of the user having dragged their finger down into the bottom margin 190 to highlight the word “The” 222. Without this margin-generating feature (i.e. pre-designated action in FIG. 5, 90 setting or defaulting to the pointer relative direction to be “Below” the selected text), then the text on the bottom line could not be selected because there would be no room for the finger to be positioned below the bottom line of text 232.

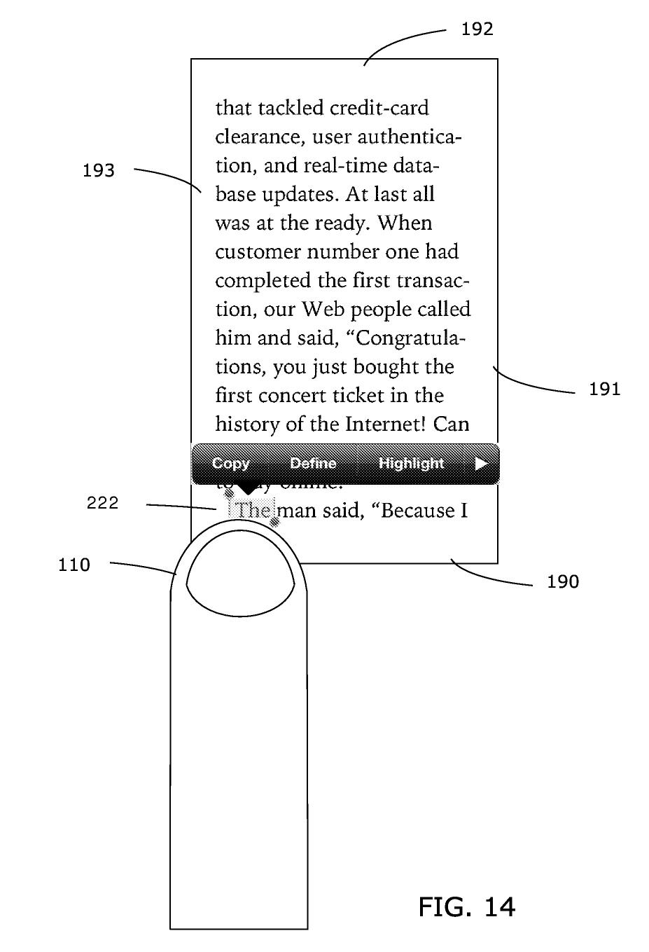

FIG. 14 illustrates an alternate embodiment of this margin-generating feature to create a margin entirely around the text (all four sides). Instead of the text just moving (e.g. moving up and losing the first line of text 208, as illustrated in FIGS. 11 and 13, 208, 212), the entire text becomes a certain percentage smaller to create margins 190-193 in all four borders of the touchscreen. Similar to having the ability to define aspects pertaining to the bounding box, embodiments may allow a user to customize which edges of the screen will implement a margin and how much of a margin will be created. Further, in some embodiments, as the margins increase, the font of the text may decrease thus leaving the pagination in the margin or non-margin states the same. The font changing function may also be enabled and customized by the user.

As non-limiting examples, possible user actions causing the margin(s) to disappear and return to the state prior to the margin-generating actions described in FIGS. 11-14, can be the user taking their pointer out of the margin either by lifting it off the touchscreen or sliding it out of the margin. Or, the margin can remain until, for example, the user does a quick double tap in a margin, or touches any other part of the touchscreen.

### CONCLUSION

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer method on a touchscreen enabled electronic computing device to facilitate viewing of a user selected text, comprising:
a. displaying on a touchscreen, a user input mechanism to receive a relative direction and distance between a user's pointer contacting the touchscreen to a user's selected text displayed on the screen;
b. detecting on the touchscreen, the user's input for relative direction and distance; and,
c. storing on the device the user's input, wherein subsequent contact by a user's pointer on the touchscreen at the relative direction and distance to the selected text increases the visibility of the selected text.

2. The computer method of claim 1, wherein the user input mechanism for a user to input a relative direction and distance comprises one or more virtual display elements selected from the group of a physical keyboard, a roller, and/or four touch arrows.

3. The computer method of claim 1, wherein increasing the visibility of the selected texts comprises highlighting the selected text in response to the user laterally sliding the pointer along the touchscreen after determining by the processor that the relative direction and distance are correct.

4. The computer method of claim 1, wherein increasing the visibility of the selected texts comprises selecting a highlighting feature from a control box that is displayed after determining by the processor that the relative direction and distance are correct.

5. The computer method of claim 1, wherein increasing the visibility of the selected text comprises displaying a bounding box around the selected text in response to the user holding the user's pointer in a fixed position after determining by the processor that the relative direction and distance are correct.

6. The computer method of claim 1, wherein the relative direction of a user's pointer contacting the touchscreen in relation to the position of the selected text is user selectable to be left, right, above, or below a desired portion of text.

7. The computer method of claim 1, further comprising displaying on the touchscreen a temporary margin for a user's pointer to contact the touchscreen near a selected text that lies along the border of the touchscreen.

8. The computer method of claim 7 comprising the processor:
a. detecting that when the selected text lies along the left, right, top or bottom border of touchscreen, then displaying on the touchscreen a temporary margin for a user's pointer to contact the touchscreen near the selected text; and,
b. wherein the margin disappears when the bounding box and/or highlighting disappear.

9. A computer method on a touchscreen enabled electronic computing device to improve the visibility of a user selected text, comprising:
a. detecting user's pointer contacting touchscreen at a pre-designated distance and relative direction from a selected text;
b. detecting when contact is laterally moved, then highlighting the selected text; and,
c. detecting when contact is held in place, then displaying a bounding box around the selected text and a control box for receiving user input to edit and highlight the selected text.

10. The computer method of claim 9, further comprising detecting when the selected text is editable, then displaying a cursor for the user to copy, paste and delete the selected text.

11. The computer method of claim 9, when the text is highlighted, further comprising displaying a highlight control bar for changing the color of the text.

12. The computer method of claim 9, further comprising displaying on the touchscreen a temporary margin for a user's pointer to contact the touchscreen near a selected text that lies along the border of the touchscreen.

13. The computer method of claim 12, comprising the processor:
a. detecting when the selected text lies along the left, right, top or bottom border of touchscreen, then displaying on the touchscreen a temporary margin for a user's pointer to contact the touchscreen near the selected text; and,
b. wherein the margin disappears when the bounding box and/or highlighting disappear.

14. An electronic computing device with enhanced visibility of text, comprising:
a. a touchscreen for receiving user touch events;
b. a processor in communication with the touchscreen and with a memory, the memory including software instructions that when accessed by the processor cause the processor to:
i. detect a user's pointer contacting the touchscreen at a pre-designated distance and relative direction from a selected text;
ii detect when the user's pointer is laterally moved, then highlight the selected text; and,
iv. detect when the user's pointer is held in place, then display a bounding box around the selected text and a control box with user input mechanisms for receiving a user input to edit the selected text.

15. The electronic computing device of claim 14, further comprising instructions that when accessed by the processor cause the processor to detect when the selected text is editable, then display a cursor for the user to copy, paste, and delete the selected text.

16. The electronic computing device of claim 14, further comprising the processor displaying on the touchscreen a control bar with user input mechanism for the user to change the color of the highlight.

17. The computer method of claim 14, further comprising displaying on the touchscreen a temporary margin for a user's pointer to contact the touchscreen near a selected text that lies along the border of the touchscreen.

18. The electronic computing device of claim 17, further comprising the processor:
a. detecting when the selected text lies along the left, right, top or bottom border of touchscreen, then displaying on the touchscreen a temporary margin for a user's pointer to contact the touchscreen near a selected text; and,
b. wherein the margin disappears when the bounding box disappears.

19. The electronic computing device of claim 16, wherein the bounding box, control box, highlighting and control bar disappear when the user touches another part of the touchscreen.
